(19) United States
(12) Patent Application Publication
(10) Pub. No.: US 2012/0110904 A1
(43) Pub. Date: May 10, 2012

(54) SYSTEM AND METHOD FOR REDUCTION OF HEAT ISLANDS THAT CONTRIBUTE TO GLOBAL WARMING

(76) Inventor: Matthew Modine, New York, NY (US)

(21) Appl. No.: 13/288,644

(22) Filed: Nov. 3, 2011

Related U.S. Application Data
(60) Provisional application No. 61/409,773, filed on Nov. 3, 2010.

(51) Int. Cl. A01G 9/02

(52) U.S. Cl. 47/65.9; 47/66.7

(57) ABSTRACT

A system and method are provided for reducing global warming. In an embodiment, a platform is provided over a surface area and supports growing at least one plant. At least one panel is coupled to the platform that comprises a plurality of solar cells. Further, at least one water storage unit is coupled to the platform and configured to collect rain water. At least a portion of the surface area is shaded as a function of the platform thereby reducing temperature of the surface area.

### RELATED APPLICATION

This application is based on and claims priority to U.S. Provisional Application Ser. No. 61/409,773, filed on Nov. 3, 2010 and entitled “SYSTEM AND METHOD FOR REDUCTION OF HEAT ISLANDS THAT CONTRIBUTE TO GLOBAL WARMING,” the entire contents of which are hereby incorporated by reference.

### BACKGROUND

### Field of the Disclosure and Related Art

In many cities and towns around the United States and the world, retail and various businesses are located in plazas and shopping malls. Often, stores and businesses in a shopping mall are arranged in a row and share a front sidewalk. Commonly referred to as “strip malls,” such centers often include various stores, businesses and/or restaurants adjacent a commonly shared parking lot. In many cases, a strip mall parking lot has a larger square area footage than the strip mall itself. Often and especially during the day, the parking lot radiates significant heat from the sun.

It is well established that global warming is an increasingly serious threat. The scientific community has issued warnings that the surface temperature of the earth continues to rise each year. It is recognized by the inventor that at least some of global warming is attributable to parking lots. As the sun shines on the asphalt or other pavement surface, the temperature of the pavement rises and the pavement continually emits heat during the day. The heat, which emanates from the pavement, is commonly referred to as a “heat island.”

It is believed by the inventor that reducing the amount of heat that emanates from, for example, strip mall parking lots will markedly reduce the deleterious impact of global warming, and will contribute to reducing the temperature of the surface area of the earth.

It is also recognized by the inventor that asphalt and other pavement surfaces have negative effects in connection with ground water, rivers and streams and other coastal ways. For example, automobiles frequently leak fluids, such as oil, anti-freeze, transmission fluid and brake fluid, which spill on to the surface of a parking lot, such as adjacent to a strip mall. The spill off from the automobiles is not absorbed by the asphalt, but instead washes, or runs-off, into the ground by the rain. Further, it is recognized by the inventor that after a rain storm, water often flows off of a rooftop and it is channeled, such as via a gutter, into the ground.

### SUMMARY

A system and method are provided for reducing global warming. In an embodiment, a platform is provided over a surface area and supports growing at least one plant. At least one panel is coupled to the platform that comprises a plurality of solar cells. Further, at least one water storage unit is coupled to the platform and configured to collect rain water. At least a portion of the surface area is shaded as a function of the platform thereby reducing temperature of the surface area.

Further and in an embodiment, the at least one plant includes at least one of a tree and grass. The surface area may include a parking lot, and at least one of a retail store and restaurant may be coupled to the platform. Moreover, in an embodiment, the system is modular and supports adding or removing solar panels and water storage units, as well as additional retail space and/or public performance space.

Features and advantages of the present application will further become apparent from the following description of the invention that refers to the accompanying drawings.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIG. 1 is an aerial view illustrating a plurality of example platform surface areas;

FIG. 2 illustrates two example platform support areas with a plurality of people disposed thereon;

FIG. 3 is an illustration of another example platform surface area that is longer than the embodiment illustrated in FIG. 2;

FIG. 4 is a rendered image that illustrates an example platform surface area in accordance with an embodiment;

FIG. 5 is an example hive-like structure that illustrates an internal structure of platform surface area;

FIG. 6 is a rendered image that illustrates another example platform surface area, in accordance with an embodiment;

FIG. 7 is a rendering of an example platform surface area, in accordance with an embodiment;

FIG. 8 is another rendering illustrating an example platform support area that includes a variety of gardens as well as solar collection panels; and

FIG. 9 illustrates a side view of an example platform support area, in accordance with an embodiment;

### DESCRIPTION OF EMBODIMENTS

The present application provides a platform surface area that, in an embodiment, may be provided with organic material, such as plants and grass. In an embodiment, the platform surface area is located over a parking lot, including for a strip mall. Also in an embodiment, one or more structures are set forth on the platform surface area, thereby providing for expansion of available commercial space. The platform surface area covers the pavement, and the organic materials, such as vegetation including trees, grass, plants and/or gardens, are noticeably and measurably cooler than asphalt pavement that absorbs heat from the sun during the course of the day.

In one or more embodiments, the present application provides a modular design that provides for a plurality of features and/or styles to be included in respective platform surface areas. Features set forth herein, including relating to solar energy, electrical generation, water storage, agriculture, and building development may be provided in various degrees and/or combinations. In an embodiment, a selection of design appearances are provided, such as a colonial design, a modern design, an industrial design and a futuristic design. The modular designs may be implemented in various way, including, but not limited to, using building techniques associated with ERECTOR SETS, LEGO bricks, 80/20 framing, BAYKO components and GIRDER AND PANEL designs. Other suitable materials and techniques for implementing the teachings herein are applicable, as well.

One or more of the design features may be provided with the platform surface area of the present application that may be customized to suit individual preferences. The preferences may be stylistic and that affect the appearance of the platform surface area, and the preferences may be functional, such as public gathering conveniences i.e. benches and relating to energy production, water storage, agriculture or the like.

For example, the platform surface area in accordance with an embodiment can be used for growing produce, including fruits and vegetables, and is suitable for food production. Further, the platform surface area may be provided with solar collecting panels to generate electricity. Thus, the teachings herein serve a dual purpose of reducing the surface area temperature of the earth, as well as to provide an aesthetically pleasing and economic revenue generating area, such as relating to food and energy production.

In addition to solar energy production and collection, the present application further may support energy production via a hydrogen-based energy source. For example, the present application may include a fuel cell system provided via a fuel cell containment system comprising at least one of water and hydrogen. One such known energy-source is described in pending U.S. patent application Ser. No. 12/069,699, and entitled SYSTEM AND METHOD FOR HYDROGEN-BASED ENERGY SOURCE, the entire disclosure of which is incorporated in its entirety herein.

Thus, the platform surface area in accordance with the teachings herein supports energy production and storage.

In addition, the platform surface area in accordance with the teachings herein may be used for a variety of entertainment purposes commonly associated with other outdoor areas. For example, music concerts, plays, and various other outdoor meeting events are supported in accordance with the teachings herein.

In an embodiment, rain and other water collection is provided, as water is channeled into water storage units, such as columns and/or water towers. The stored water is available for future use, such as for watering plants provided with the platform surface area during a dry spell or a drought, thereby reducing or eliminating a need to tap into wells or public water sources that would otherwise deplete the ground water table.

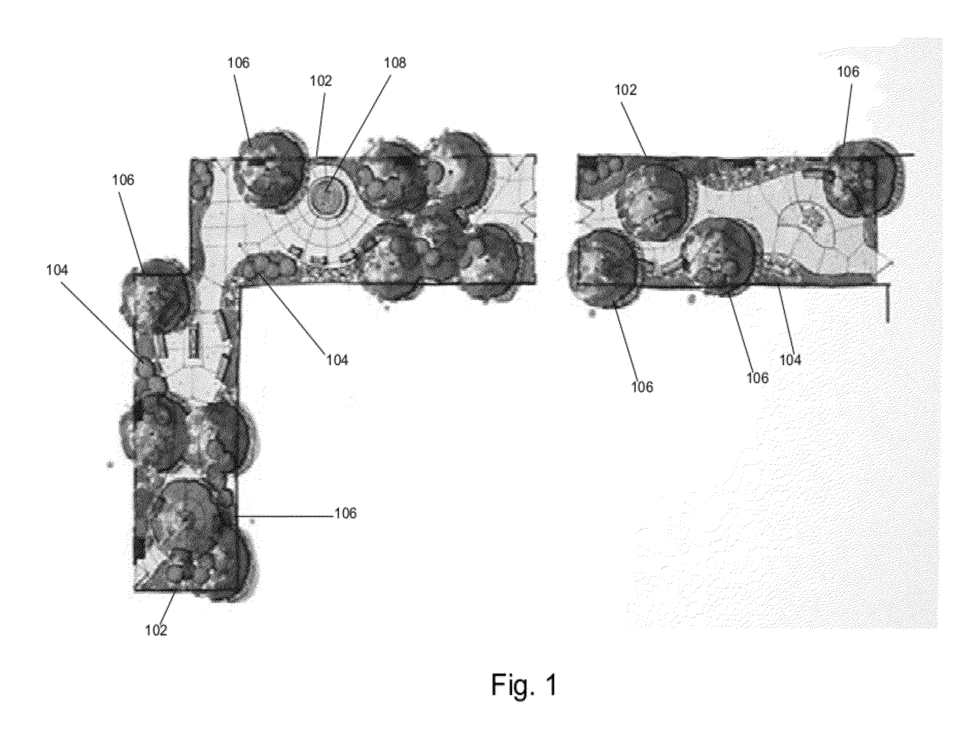

Referring now to the drawings, in which like reference numerals refer to like elements, FIG. 1 is an aerial view illustrating a plurality of example platform surface areas 102. Included in FIG. 1 are a plurality of plants 104 and roof coverings 106 that provide shaded areas on platform surface area 102 for, for example, restaurant and retail space. Further, water column 108 is illustrated that collects and stores rainwater that may be channeled thereto. The platform surface areas 102 shown in FIG. 1 are preferably adjacent strip malls or other commercial areas (not shown), and cover parking lots and other asphalt or surfaces, such as cement, that collect and radiate heat from the sun.

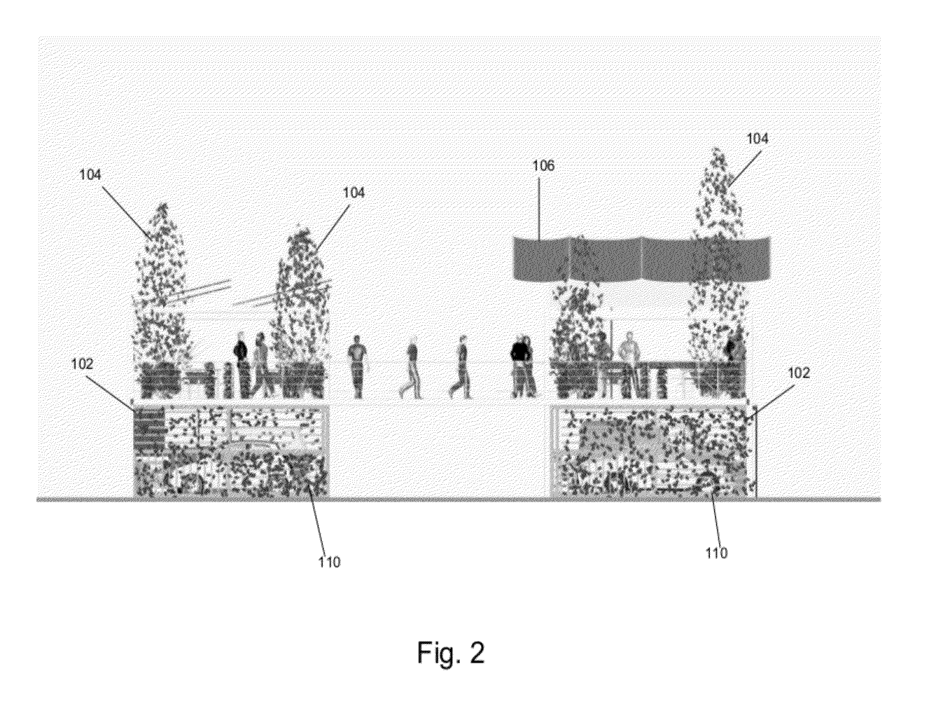

FIG. 2 illustrates two example platform support areas 102 with a plurality of people disposed thereon. As shown in FIG. 2, automobiles 110 are parked beneath the covered platform support areas 102, and sunlight is blocked by platform support areas 102 from reaching the pavement. A variety of plantings 104 are disposed on platform support areas 102, including trees and shrubbery. Further, roof covering 106 is shown, which provides additional shade.

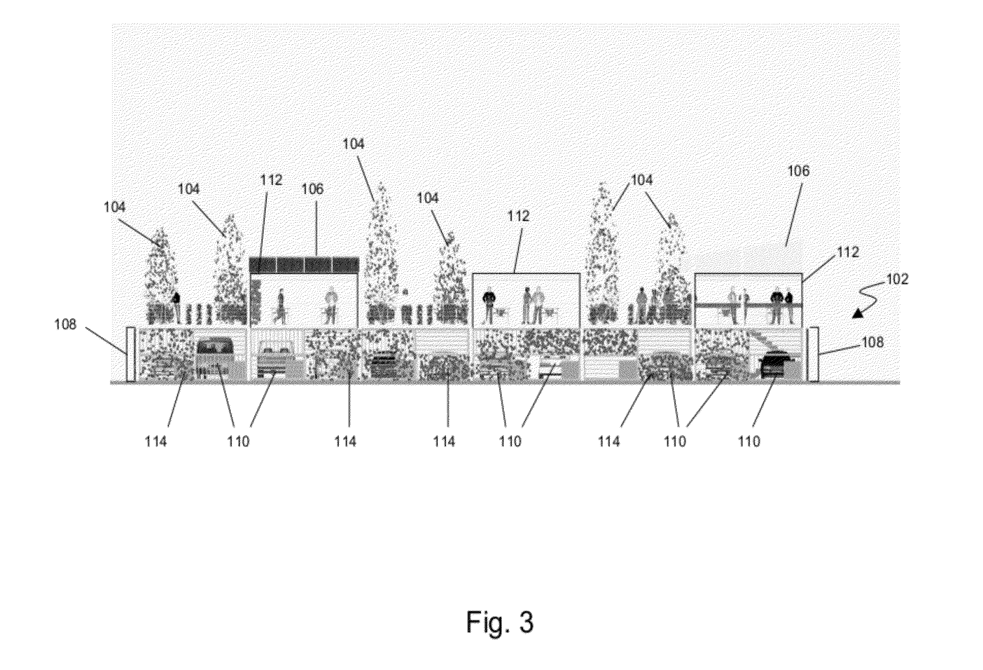

FIG. 3 is an illustration of another example platform surface area 102 that is longer than that illustrated in FIG. 2. In the example platform support area 102 shown in FIG. 3, gathering areas 112 are illustrated, which may include, for example, retail space, restaurant space, or other commercial or non-commercial space. In the example shown in FIG. 3, tables and seats are provided, as well as people converging in areas 112. Further, a plurality of automobiles 110 are illustrated beneath platform surface area 102. To provide further shade, side and wall surfaces 114 are provided with plants, such as ivy or other vine-like plants that intertwine along a plurality of vertical and/or horizontal slats. In this way, platform surface area 102 provides an organic and “green” appearance as plants cover the side and wall surfaces 114 of platform surface area 102, as well as providing for further shade.

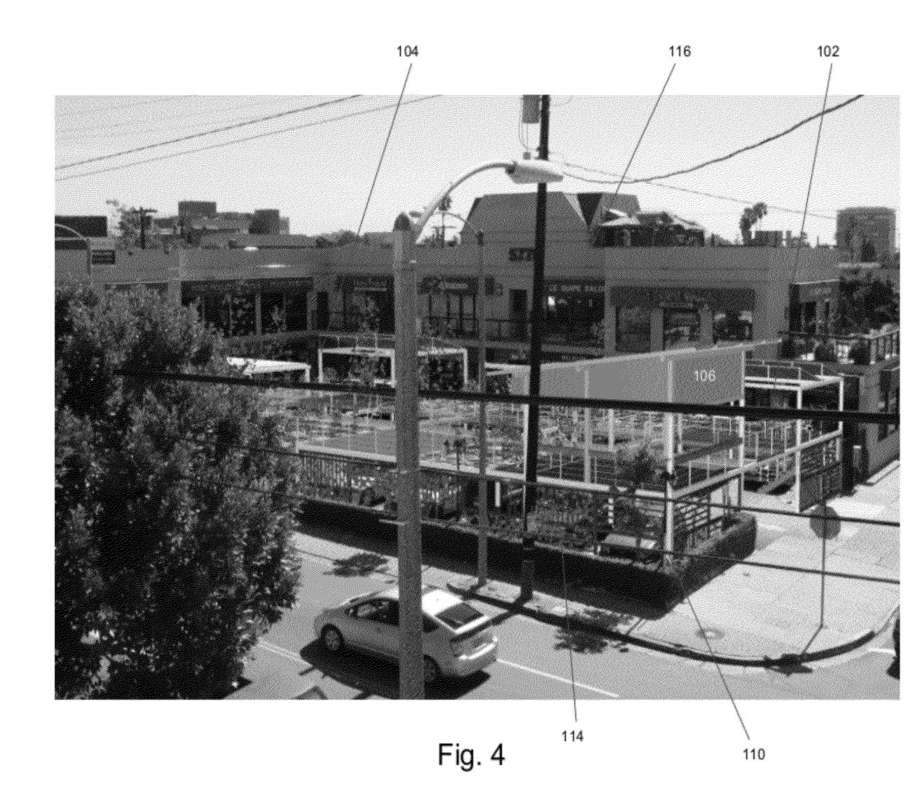

FIG. 4 is a rendered image that illustrates an example platform surface area 102 in accordance with an embodiment. As shown in FIG. 3, strip mall 116 includes a plurality of retail and office establishments, and a shared parking lot is adjacent thereto. Automobiles 110 are preferably parked beneath platform surface area 102. Platform surface area 102 includes shrubbery and growth, including on side and wall surfaces 114 to provide additional shade for the parking lot.

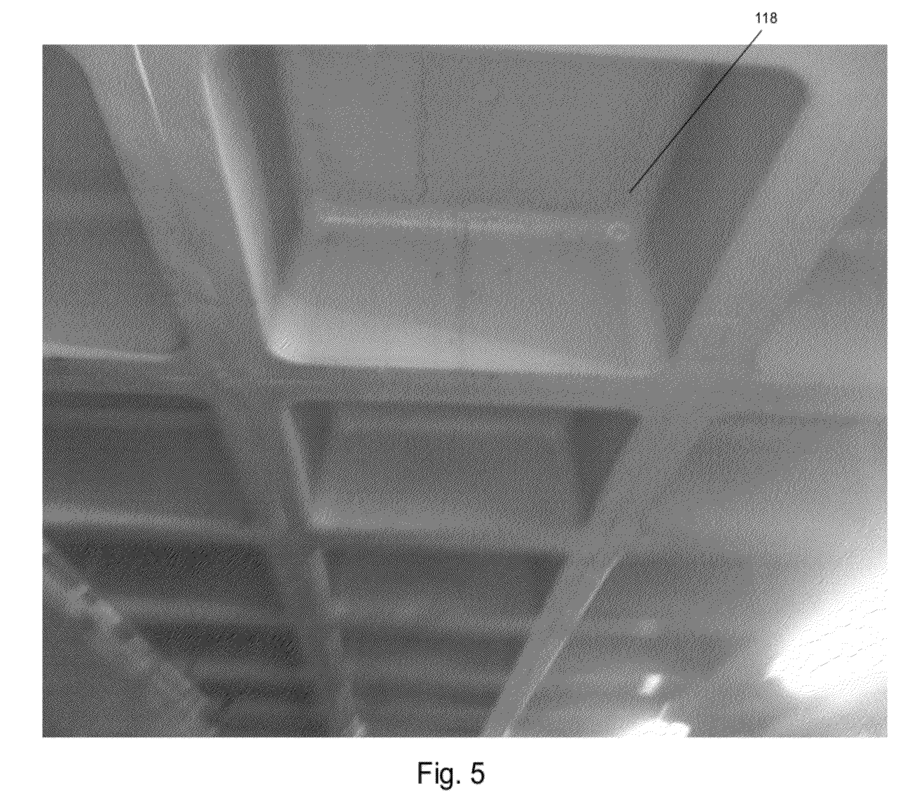

FIG. 5 is an example hive-like structure that illustrates an internal structure of platform surface area 102. As shown in FIG. 5, substantially rectangular cells 118 are provided and that provide support for the weight of building structures, people, plants and materials provided on platform surface area 102.

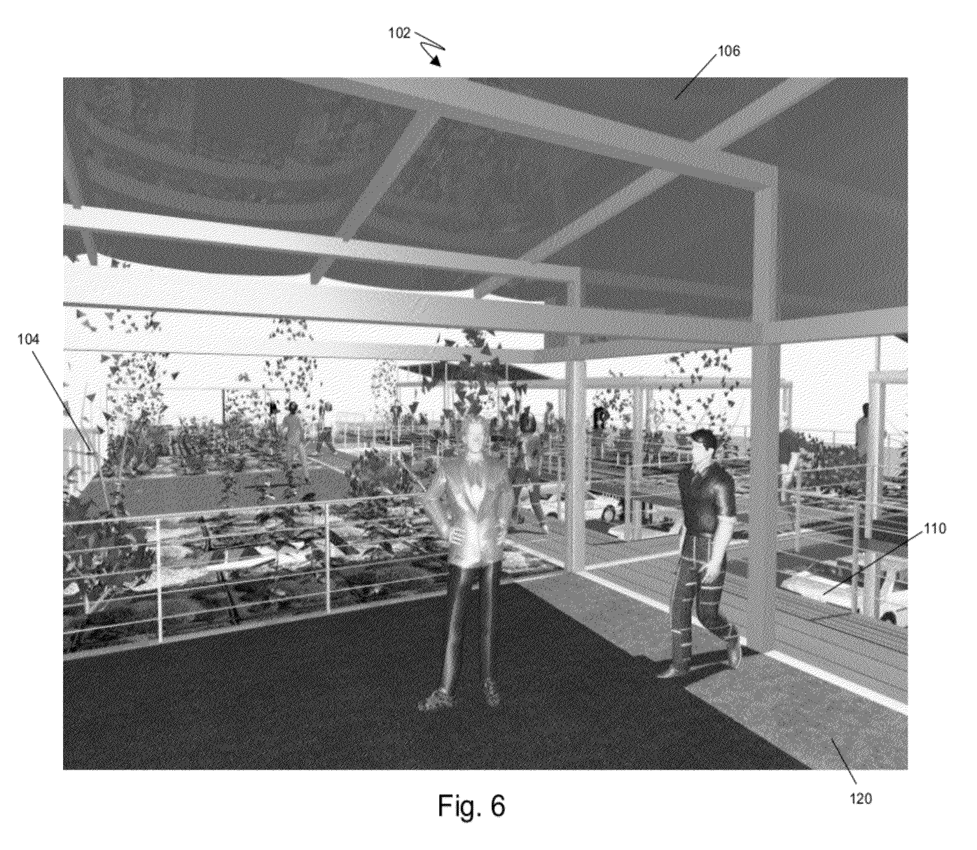

FIG. 6 is a rendered image that illustrates another example platform surface area 102 in accordance with an embodiment. As shown in FIG. 6, a plurality of people are standing on grass lawn 120 that is planted on a platform support in accordance with the teachings herein. A plurality of automobiles 110 are illustrated parked beneath platform support area 102 and are shielded from the sun. Further, the example platform area surface 102 shown in FIG. 6 is provided with roof cover 106 that may be provided as a flexible roof and that is attached to cross beams. This provides additional shade. Further, a variety of plants and other plants and shrubbery 104 are illustrated in FIG. 6.

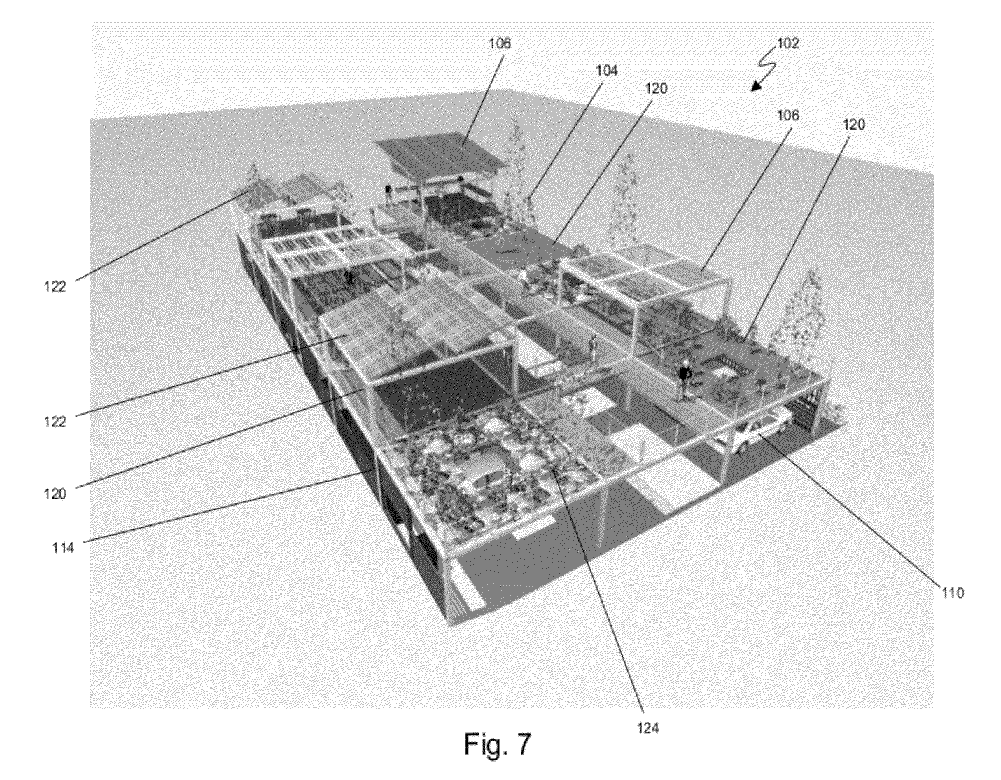

In an embodiment, solar collectors are included with platform surface area 102 that enable light to pass through and that convert the collected sunlight into electricity. FIG. 7 is a rendering of an example platform surface area 102 in accordance with an embodiment. In the example shown in FIG. 7, solar collection panels 122 are illustrated above grass lawn 120 and that are configured to generate electricity. Also as shown in FIG. 7, garden 124 is illustrated, which includes smaller lots for, for example, vegetable and/or fruit plants. Thus, in addition to reducing heat by shading asphalt surfaces, platform surface 102 operates to generate electricity via solar panels 122 and to grow food and vegetables via garden 124.

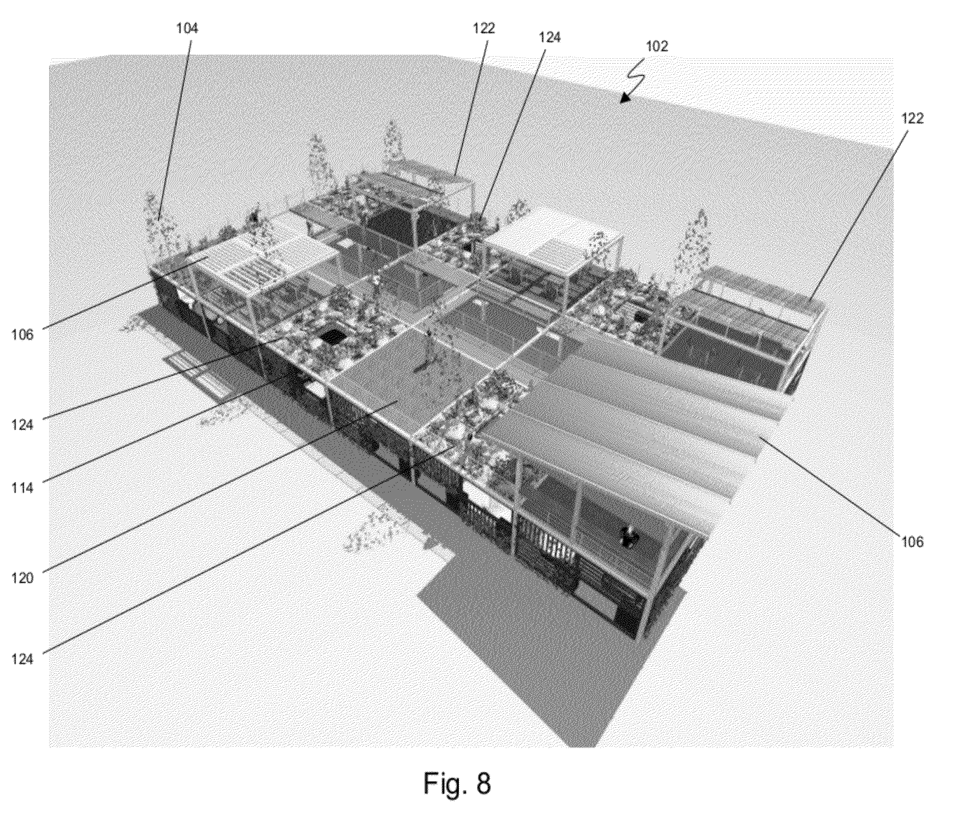

FIG. 8 is another rendering illustrating an example platform support area 102 that includes a variety of gardens 124, as well as solar collection panels 122.

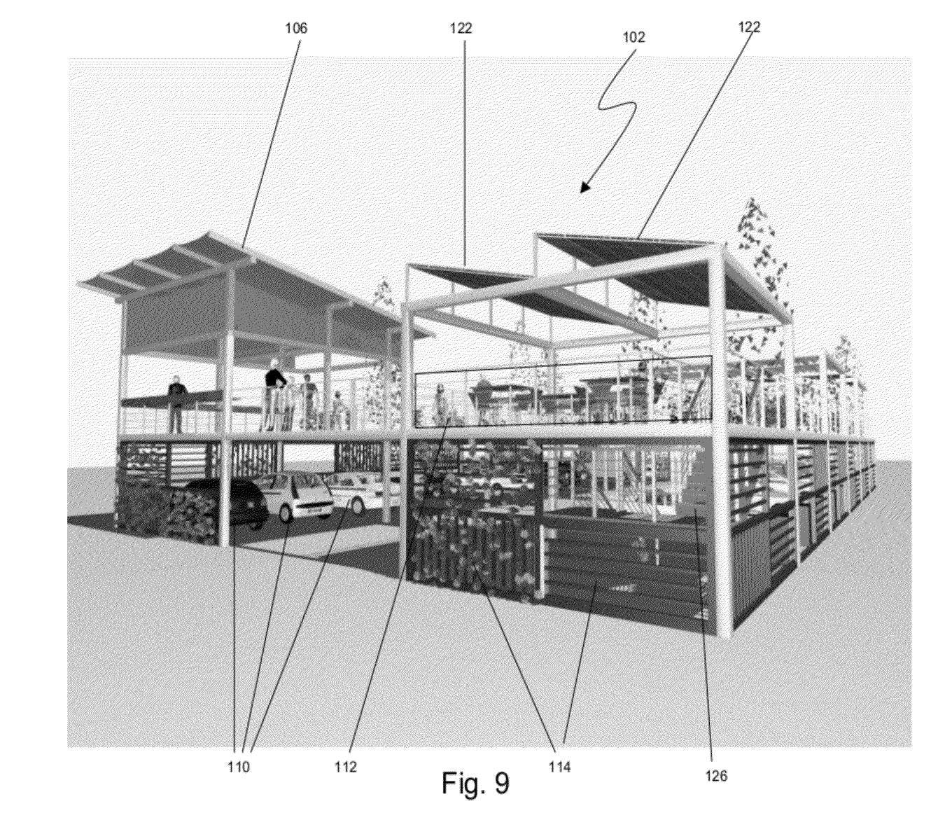

FIG. 9 illustrates a side view of an example platform support area 102 in accordance with an embodiment. As shown in the example of FIG. 9, stairs 126 are provided to enable people to go to and from their automobiles 110 that are parked beneath area 102. Also illustrated in FIG. 9, solar collection panels 122, gathering area 112, side and wall surfaces 114 and roofs 106 are provided with platform support area 102.

Thus, platform support area 102 may form various kinds of public areas operable to support vegetation, including trees, gardens and other vegetation, while operating to reduce heat emissions that contribute to global warming. Further, in a preferred embodiment, commercial space, including retail and restaurant establishments, may be provided on platform support area 102. Public space may also be provided for performance areas, such as for musical and other performances. Additionally, water columns 118 may be provided to receive rain water that may be channeled via one or more conduits for a water supply source useable, for example, to water plants and lawns provided on or with platform support area 102. Moreover, solar collectors 122 are preferably provided that collect sunlight and generate electricity.

In various embodiments, platform support area 102 is provided with side and wall surfaces 114 that are formed of horizontally and/or vertically placed slats thereby enabling air to flow through which contributes to keeping the parking area beneath platform support area 102 cool. In an example embodiment, one or more plantings is provided on side and wall surfaces 114, thereby extending the shade from the sun and to provide an aesthetically pleasing “green” appearance.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A system for reducing global warming, the system comprising:
a platform provided over a surface area, wherein the platform supports growing at least one plant;
at least one panel coupled to the platform that comprises a plurality of solar cells; and
at least one water storage unit coupled to the platform that is configured to collect rain water,
wherein at least a portion of the surface area is shaded as a function of the platform thereby reducing temperature of the surface area.

2. The system of claim 1, wherein the at least one plant includes at least one of a tree and grass.

3. The system of claim 1, wherein the surface area include a parking lot.

4. The system of claim 1, further comprising at least one of a retail store and a restaurant coupled to the platform.

5. The system of claim 4, wherein the at least one of the retail store and the restaurant are provided on the platform.

6. The system of claim 1, wherein the system is modular and supports adding or removing solar panels and water storage units.

7. The system of claim 1, wherein the system is formatted in one or more of a colonial design, an industrial design or a futuristic design.

8. The system of claim 1, wherein the platform supports a public gathering space.

9. A method for reducing global warming, the system comprising:
providing a platform over a surface area, wherein the platform supports growing at least one plant;
coupling at least one panel to the platform that comprises a plurality of solar cells; and
coupling at least one water storage unit to the platform that is configured to collect rain water,
wherein at least a portion of the surface area is shaded as a function of the platform thereby reducing temperature of the surface area.

10. The method of claim 9, wherein the at least one plant includes at least one of a tree and grass.

11. The method of claim 9, wherein the surface area include a parking lot.

12. The method of claim 9, further coupling at least one of a retail store and a restaurant to the platform.

13. The method of claim 12, further comprising providing the at least one of the retail store and the restaurant on the platform.

14. The method of claim 9, further comprising coupling additional solar panels and water storage units to the platform.

15. The method of claim 9, further comprising formatting the platform in one or more of a colonial design, an industrial design or a futuristic design.

16. The method of claim 9, wherein the platform supports a public gathering space.
